(19) United States
(12) Patent Application Publication
(10) Pub. No.: US 2022/0012761 A1
(43) Pub. Date: Jan. 13, 2022

(54) PERSONALIZED AMBIENT NOISE RELAY SYSTEM

(71) Applicant: Cheol Su KIM, Seoul (KR)

(72) Inventor: Cheol Su KIM, Seoul (KR)

(21) Appl. No.: 17/294,400

(22) PCT Filed: Nov. 13, 2019
(86) PCT No.: PCT/KR2019/015402

§ 371 Date: May 15, 2021

(30) Foreign Application Priority Data
Nov. 15, 2018 (KR) 10-2018-0140609

(51) Int. Cl. G06Q 30/02

(52) U.S. Cl. CPC G06Q 30/0214; G06Q 30/0277; G06Q 30/0258; G06Q 30/0239

(57) ABSTRACT

The present invention relates to a customized noise relay system capable of providing noise services with functional usefulness and emotional value to users by providing various noises created by people in an urban living environment or a natural environment according to the characteristics of wired/wireless Internet services. The customized noise relay system according to a first embodiment of the present invention includes a noise management center 1100 for directly outputting a noise to a noise user accessing an Internet site via wired or wireless connection, wherein the noise management center 1100 includes a noise management unit 1110 for managing noises; a noise list providing unit 1120 for displaying a list of noises managed by the noise management unit 1110 to allow a user accessing an Internet site linked to the noise management center 1100 to check the list; and a noise output unit 1130 for outputting a noise selected by the user from the displayed noise list.

### TECHNICAL FIELD

The present invention relates to a customized noise relay system capable of increasing functional and emotional values by providing various noises generated by people in offline places according to the characteristics of wired/wireless Internet services used by users.

### BACKGROUND ART

In general, people may hear any sound as noise depending on their surroundings. The feeling of a certain sound depends on the individual's subjective sense. Thus, a certain sound may be unpleasant to some and pleasant to others.

Some websites provide the sounds of nature, such as the sound of valleys, the sound of waves, and the sound of raindrops, to improve learning efficiency or to induce sleep. In addition, artificially created sounds, such as the sound of eating snacks, are provided through YouTube. However, the methods of providing sounds through the Internet have limitations in that the methods unilaterally provide stored natural sounds or artificial sounds to users.

### DISCLOSURE

### Technical Problem

Therefore, the present invention has been made in view of the above problems, and it is one object of the present invention to provide a customized noise relay system capable of providing noise services with functional usefulness and emotional value to users by providing various noises created by people in an urban living environment or a natural environment according to the characteristics of wired/wireless Internet services.

It is another object of the present invention to provide a customized noise relay system that allows users to always receive noises required by the users through a website or a mobile service by providing noises generated in offline places through a registered customized dedicated noise terminal.

It is yet another object of the present invention to provide a customized noise relay system capable of providing realistic and vivid noise services to users by providing noises generated in offline places to the users in real time or in a way of storing noises. In addition, according to the present invention, when using the customized noise relay system, users may feel offline analog sensibility, such as memories and longing, through online or mobile services.

### Technical Solution

In accordance with one aspect of the present invention, provided is a customized noise relay system according to a first embodiment of the present invention, including a noise management center (1100) for directly outputting a noise to a noise user accessing an Internet site via wired or wireless connection,

wherein the noise management center (1100) includes a noise management unit (1110) for managing noises; a noise list providing unit (1120) for displaying a list of noises managed by the noise management unit (1110) to allow a user accessing an Internet site linked to the noise management center (1100) to check the list; and a noise output unit (1130) for outputting a noise selected by the user from the displayed noise list.

In accordance with another aspect of the present invention, provided is a customized noise relay system according to a second embodiment of the present invention, including a noise management center (2100) for directly outputting a noise to a noise user accessing an Internet site via wired or wireless connection; and a noise registration terminal (2200) for registering noises in the noise management center (2100),

wherein the noise management center (2100) includes a noise management unit (2110) for managing noises; a noise list providing unit (2120) for displaying a list of noses managed by the noise management unit (2110) to allow a user accessing an Internet site linked to the noise management center (2100) to check the list; a noise output unit (2130) for outputting a noise selected by the user from the displayed noise list; a noise registrant management unit (2150) for storing and managing information about noise registrants who wish to register noise files or real-time field noises; a noise usage information management unit (2160) that is connected to the noise management center (2100) to manage a usage history of a noise user using noises; and a noise usage income calculation unit (2170) for, when income arises by outputting of noises, calculating a noise usage cost and paying the noise usage cost to registrants who have registered the noises, and

the noise registration terminal (2200) includes a noise registration unit (2210) that is connected to the noise management center (2100) to register recorded noise files or real-time field noise information; a noise usage history management unit (2220) for receiving and managing a noise usage history when a registered noise is output or provided to a noise user through an Internet site linked to the noise management center (2100); and a noise usage cost management unit (2230) for, when a cost incurred by a registered noise used through the noise management center (2100) is calculated, receiving and managing the calculated information.

In accordance with still another aspect of the present invention, provided is a customized noise relay system according to a third embodiment of the present invention, including a noise management center (3100) for providing a matched dedicated noise to a customized dedicated noise output terminal (3200) via wired or wireless connection; and the customized dedicated noise output terminal (3200) for outputting the dedicated noise received from the noise management center (3100),

wherein the noise management center (3100) includes a noise management unit (3110) for managing noises; a dedicated noise user registration unit (3120) for registering information about users who always want to receive a specific noise; a customized dedicated noise output terminal registration unit (3130) for registering and managing information about a dedicated noise terminal that always receives a specific noise from a dedicated noise user; a dedicated noise matching unit (3140) for matching a noise selected by the dedicated noise user with the customized dedicated noise output terminal (3200) registered by the dedicated noise user and storing the noise; and a dedicated noise transmission unit (3150) for providing a dedicated noise to the customized dedicated noise output terminal (3200) of the dedicated noise user stored in the dedicated noise matching unit (3140).

In accordance with yet another aspect of the present invention, provided is a customized noise relay system according to a fourth embodiment of the present invention, including a noise management center (4100) for providing noises to a noise application (4200) of a user terminal via wired or wireless connection; and a user terminal installed with the noise application (4200) for outputting noises received from the noise management center (4100),

wherein the noise management center (4100) includes a noise management unit (4110) for managing noises; a noise application management unit (4120) for managing information about the noise application (4200) installed in the user terminal; a noise list providing unit (4130) for providing a list of noises managed by the noise management unit (4110) to the noise application (4200) linked to the noise management center (4100); a noise request receiving unit (4140) for receiving a request for a noise selected by a user from the noise application (4200) of the user terminal; and a noise transmission unit (4150) for transmitting a noise received by the noise request receiving unit (4140) to the noise application (4200) of the user terminal, and

the noise application (4200) includes an identification item management unit (4210) for storing unique identification information of the noise application (4200) stored in the terminal; a noise list display unit (4220) for displaying the noise list received from the noise management center (4100) on a screen; a noise request unit (4230) for, when a user selects a noise from the noise list displayed on the screen, requesting transmission of the selected noise to the noise management center (4100); a noise receiving unit (4240) for receiving a noise file transmitted from the noise management center (4100); and a noise playback unit (4250) for playing the noise received by the noise receiving unit (4240).

### Advantageous Effects

A customized noise relay system according to the present invention can provide various noises generated in offline places according to the characteristics of wired/wireless Internet services used by users. Accordingly, the present invention can provide users with a new type of service that the users have not experienced before.

In addition, according to the present invention, a user can hear a registered noise of a specific place or a real-time field noise through an Internet site or a noise application. Thereby, memories can be revived, and longing or desire to purchase can be stimulated. In addition, the user can use the service in real time while feeling a sense of reality. For example, a user can hear the noise of a gym when exercising at home, a user can hear the noise of the Manhattan store, which is the headquarters of Starbucks, while drinking coffee at home, a user can hear the kitchen noise of a famous chef while cooking, a user can hear the noise of an offline store when shopping for fresh food, and a user can hear the noise of Amsterdam streets, Boracay Beach, or Central Park when he or she wants to travel.

In addition, since a user can output a selected noise using a customized dedicated noise output terminal such as various websites, AI speakers, mobile terminals, smartphones, and TVs, the user can feel an increased sense of reality by selecting a website or an application according to the desired noise.

In addition, compared with video services such as YouTube, playing real-time noises or stored noises can significantly reduce wired and wireless Internet usage.

### DESCRIPTION OF DRAWINGS

FIG. 1 is a block diagram of a customized noise relay system according to a first embodiment of the present invention.

FIG. 2 is a block diagram of a customized noise relay system according to a second embodiment of the present invention.

FIG. 3 is a block diagram of a customized noise relay system according to a third embodiment of the present invention.

FIG. 4 is a block diagram of a customized noise relay system according to a fourth embodiment of the present invention.

### BEST MODE

Hereinafter, embodiments of the present invention will be described with reference to the accompanying drawings.

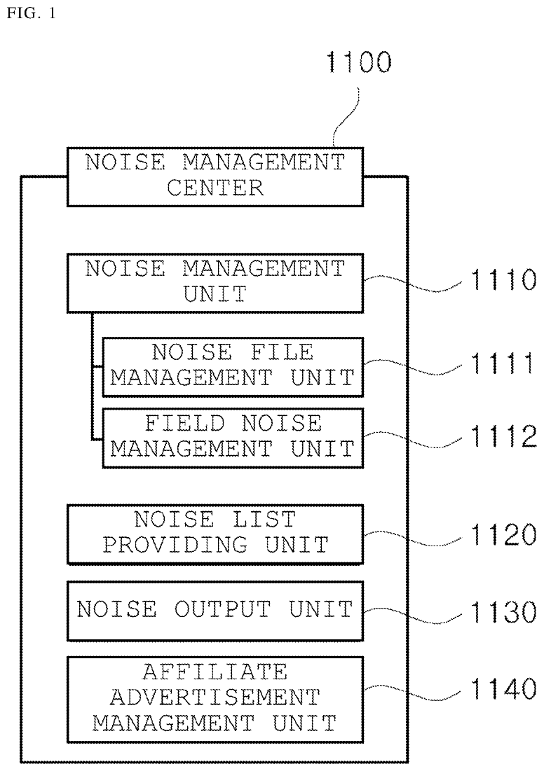

As shown in FIG. 1, a customized noise relay system according to a first embodiment of the present invention includes a noise management center 1100 for directly outputting a noise to a noise user accessing an Internet site via wired or wireless connection. The noise management center 1100 provides a homepage for outputting noises through the Internet.

The noise management center 1100 includes a noise management unit 1110, a noise list providing unit 1120, a noise output unit 1130, and an affiliate advertisement management unit 1140.

The noise management unit 1110 manages information about noises. The noise management unit 1110 consists of a noise file management unit 1111 and a field noise management unit 1112.

The noise file management unit 1111 stores recorded noise files in a noise DB and manages the recorded noise files. In this case, the noise management unit stores noise files, noise names, etc. in the noise DB. For example, the noise files include a noise generated when selling fruit in the market, a noise generated from a store in a specific area, a street noise in a specific area, etc., photos, and videos.

The field noise management unit 1112 manages field noise information so as to receive a noise from a field in real time. In this case, the field noise management unit 1112 receives a noise from a field through real time streaming, and stores information about the location of the noise, the type of the noise, and an address provided through streaming. For example, the field noise includes images, videos, and noises provided through real-time streaming, such as a noise from the Starbucks headquarters, a noise from a supermarket, a department store, or a traditional market in a specific area, a restaurant noise, a street noise in a certain city, a noise from a certain park, a noise from a certain museum, and a noise from a certain church.

The noise list providing unit 1120 displays a list of noises managed by the noise management unit 1110 to allow a user accessing an Internet site linked to the noise management center 1100 to check the list. In this case, when the noise list is a noise file, a ‘Listen’ menu and a ‘Download’ menu are preferably displayed at the same time. When the noise list is a field noise, a ‘Listen’ menu is preferably displayed. In addition, on the noise list, popular noises may be provided in a ranking order for each field according to the number of times selected by a user. In addition, the noise list may be classified and provided as a recommended list for each situation.

When a noise is selected by a user from the displayed noise list, the noise output unit 1130 outputs the selected noise. Accordingly, a user accessing an Internet site linked to the noise management center 1100 may select and hear a noise. When a ‘Listen’ menu is selected from the noise list, the noise output unit 1130 outputs the selected noise to the Internet site. When a ‘Download’ menu is selected, the noise output unit 1130 provides the selected noise file to the terminal of the user accessing the Internet site.

The affiliate advertisement management unit 1140 registers information about an advertisement sound or a discount coupon sound that is output while a noise is being output, and outputs the registered advertisement sound or discount coupon sound to the output noise. In this case, when the discount coupon sound is output, a discount coupon is also preferably displayed on a screen.

When the customized noise relay system according to the first embodiment is used, a user with a wired or wireless terminal may access an Internet site linked to the noise management center 1100 and may hear registered noises or real-time field noises generated from a specific area. Thus, memories may be revived, or the user may experience the feeling of the field in real time. For example, a user may hear the noise of a gym when exercising at home, a user may hear the noise of the Starbucks headquarters store while drinking coffee at home, a user may hear a restaurant noise while eating, and a user may hear the noise of Amsterdam streets, Boracay Beach, or Manhattan Streets when he or she wants to travel.

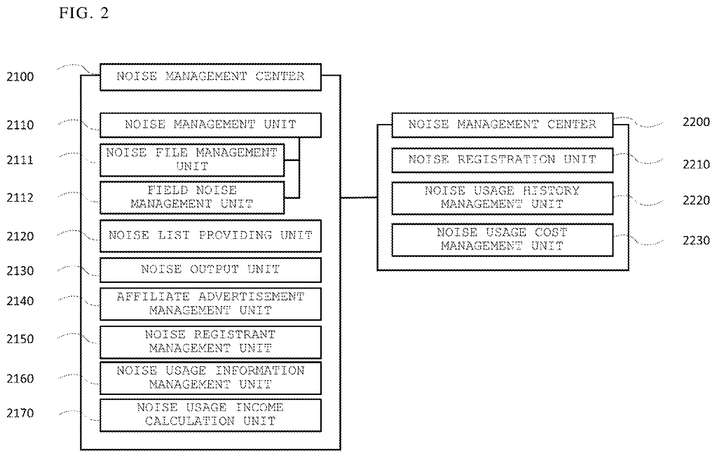

As shown in FIG. 2, a customized noise relay system according to a second embodiment of the present invention includes a noise management center 2100 for directly outputting a noise to a noise user accessing an Internet site via wired or wireless connection and a noise registration terminal 2200 for registering noises in the noise management center 2100.

The noise management center 2100 includes a noise management unit 2110, a noise list providing unit 2120, a noise output unit 2130, an affiliate advertisement management unit 2140, a noise registrant management unit 2150, a noise usage information management unit 2160, and a noise usage income calculation unit 2170.

The noise management unit 2110 manages information about noises. The noise management unit 2110 consists of a noise file management unit 2111 and a field noise management unit 2112.

The noise file management unit 2111 stores recorded noise files in a noise DB and manages the recorded noise files. In this case, the noise management unit stores noise files, noise names, noise registrants, etc. in the noise DB.

The field noise management unit 2112 manages field noise information so as to receive a noise from a field in real time. In this case, the field noise management unit 2112 receives a noise from a field through real time streaming, and stores information about the location of the noise, the type of the noise, an address provided through streaming, and the like.

The noise list providing unit 2120 displays a list of noises managed by the noise management unit 2110 to allow a user accessing an Internet site linked to the noise management center 2100 to check the list. In this case, when the noise list is a noise file, a ‘Listen’ menu and a ‘Download’ menu are preferably displayed at the same time. When the noise list is a field noise, a ‘Listen’ menu is preferably displayed. In addition, on the noise list, popular noises may be provided in a ranking order for each field according to the number of times selected by a user. In addition, the noise list may be classified and provided as a recommended list for each situation.

When a noise is selected by a noise user from the displayed noise list, the noise output unit 2130 outputs the selected noise. Accordingly, a user accessing a homepage linked to the noise management center 2100 may select and hear a noise.

The affiliate advertisement management unit 2140 registers information about an advertisement sound or a discount coupon sound that is output while a noise is being output, and outputs the registered advertisement sound or discount coupon sound to the output noise. In this case, when the discount coupon sound is output, a discount coupon is also preferably displayed on a screen.

The noise registrant management unit 2150 stores and manages information about noise registrants who wish to register noise files or real-time field noises.

The noise usage information management unit 2160 is connected to the noise management center 2100 to manage a usage history of a noise user using noises. In this case, when a noise used is a noise provided by a noise registrant, a usage history is provided to the noise registration terminal 2200.

When income arises by outputting of noises, the noise usage income calculation unit 2170 calculates a noise usage cost and pays the noise usage cost to registrants who have registered the noises. In this case, when a noise provided for a fee is output or a noise matched with an advertisement is output, income for a noise includes advertisement costs and the like.

In addition, the noise registration terminal 2200 includes a noise registration unit 2210, a noise usage history management unit 2220, and a noise usage cost management unit 2230.

The noise registration unit 2210 is connected to the noise management center 2100 to register recorded noise files or real-time field noise information. In this case, the real-time field noise information includes information about the location of a noise, the type of a noise, an address provided through streaming, and the like.

When a registered noise is output or provided to a noise user through an Internet site linked to the noise management center 2100, the noise usage history management unit 2220 receives and manages a noise usage history.

When a cost incurred by a registered noise used through the noise management center 2100 is calculated, the noise usage cost management unit 2230 receives and manages the calculated information.

When the customized noise relay system according to the second embodiment is used, a user with a wired or wireless terminal may access a homepage linked to the noise management center to hear noises generated from a specific area or real-time field noises. A noise registrant may register noise files or real-time field noises in the noise management center, and may be provided with income generated by the registered noises.

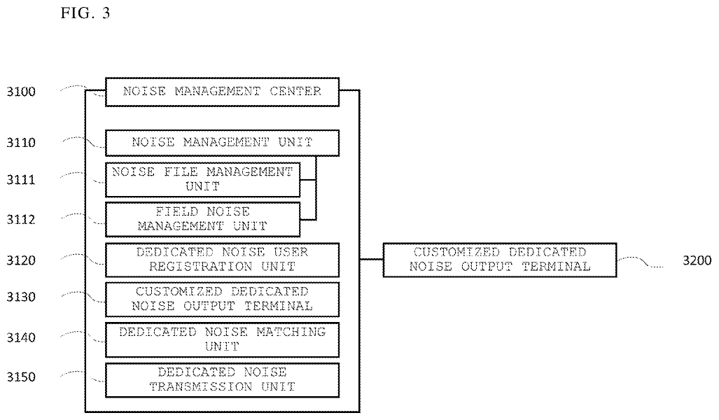

As shown in FIG. 3, a customized noise relay system according to a third embodiment of the present invention includes a noise management center 3100 for providing a matched dedicated noise to a terminal of a dedicated noise user via wired or wireless connection and a customized dedicated noise output terminal 3200 for outputting the dedicated noise received from the noise management center 3100.

The noise management center 3100 includes a noise management unit 3110, a dedicated noise user registration unit 3120, a customized dedicated noise output terminal registration unit 3130, a dedicated noise matching unit 3140, and a dedicated noise transmission unit 3150.

The noise management unit 3110 manages information about noises. The noise management unit 3110 consists of a noise file management unit 3111 and a field noise management unit 3112.

The noise file management unit 3111 stores recorded noise files in a noise DB and manages the recorded noise files. In this case, the noise management unit stores noise files, noise names, field images, etc. in the noise DB. Noise files may be registered by a noise registrant.

The field noise management unit 3112 manages field noise information so as to receive a noise from a field in real time. In this case, the field noise management unit 3112 receives a noise from a field through real time streaming, and stores information about the location of the noise, the type of the noise, and an address provided through streaming. Field noises may be registered by a noise registrant.

The dedicated noise user registration unit 3120 registers information about users who always want to receive a specific noise.

The customized dedicated noise output terminal registration unit 3130 registers and manages information about a dedicated noise terminal that always receives a specific noise from a dedicated noise user. In this case, the customized dedicated noise output terminal includes websites that sell products online while receiving a specific noise, online sites such as blogs and commerce, AI speakers, portable terminals, smartphones, and TVs.

The dedicated noise matching unit 3140 matches a noise selected by a dedicated noise user to the customized dedicated noise output terminal 3200 registered by the dedicated noise user and stores the noise. In this case, a dedicated user may match different noises for each web page when registering a site. A dedicated user may match different noises for each terminal when registering multiple terminals. For example, a user may match the real-time on-site noise of the Starbucks headquarters store to a Starbucks sales site that sells Starbucks products online. In the case of a web page that sells fruit, a user may match the noise of a fruit corner of a traditional market or a supermarket. In the case of a web page for ordering food, a user may match the noise of a store selling food.

The dedicated noise transmission unit 3150 provides a dedicated noise to the customized dedicated noise output terminal 3200 stored in the dedicated noise matching unit 3140.

In addition, the customized dedicated noise output terminal 3200 outputs a dedicated noise received from the noise management center 3100. The customized dedicated noise output terminal 3200 includes websites that sell products online, blogs, commerce, AI speakers, portable terminals, smartphones, and TVs. In this case, when the dedicated noise is afield noise, the dedicated noise is provided in a streaming manner.

By using the customized noise relay system according to the third embodiment, a noise selected by a dedicated noise user may be transmitted from the noise management center 3100 to the customized dedicated noise output terminal 3200 such as a website, an AI speaker, a mobile terminal, a smartphone, and a TV, and may be output.

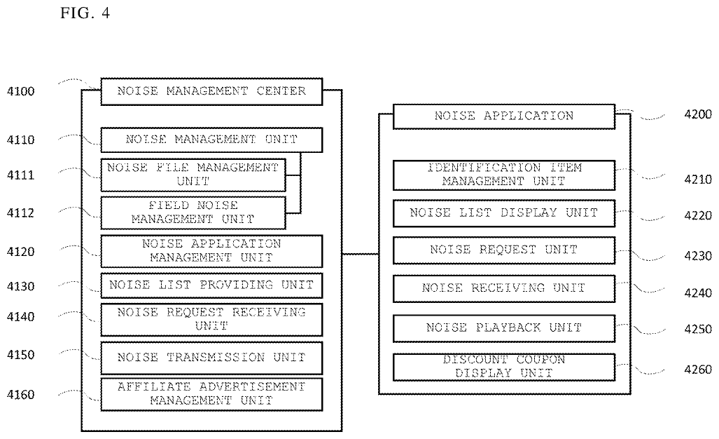

As shown in FIG. 4, a customized noise relay system according to a fourth embodiment of the present invention includes a noise management center 4100 for providing noises to a noise application 4200 of a user terminal via wired or wireless connection and the user terminal installed with the noise application 4200 for outputting noises received from the noise management center 4100.

[1] The noise management center 4100 includes a noise management unit 4110, a noise application management unit 4120, a noise list providing unit 4130, a noise request receiving unit 4140, a noise transmission unit 4150, and an affiliate advertisement management unit 4160.

The noise management unit 4110 manages information about noises. The noise management unit 4110 consists of a noise file management unit 4111 and a field noise management unit 4112.

The noise file management unit 4111 stores recorded noise files in a noise DB and manages the recorded noise files. In this case, the noise management unit stores noise files, noise names, etc. in the noise DB. The noise files may be registered by a noise registrant.

The field noise management unit 4112 manages field noise information so as to receive a noise from a field in real time. In this case, the field noise management unit 4112 receives field noises through real time streaming, and stores information about the location of the noise, the type of the noise, the address of streaming, and the like. The field noises may be registered by a noise registrant.

The noise application management unit 4120 manages information about the noise application 4200 installed in a user terminal. Through the noise application management unit 4120, various information about noises may be provided while communicating with the noise application 4200 installed in a user terminal. In addition, the location and usage time of a user who uses a noise application and the gender, age, and occupation (when the user is a member) of the user are checked, and a customized advertisement sound or discount coupon information may be provided to the user.

The noise list providing unit 4130 provides a list of noises managed by the noise management unit 4110 to a noise application linked to the noise management center 4100. In this case, when the noise list is a noise file, a ‘Listen’ menu and a ‘Download’ menu are preferably displayed at the same time. When the noise list is a field noise, a ‘Listen’ menu is preferably displayed. In addition, on the noise list, popular noises may be provided in a ranking order for each field according to the number of times selected by a user. In addition, the noise list may be classified and provided as a recommended list for each situation.

The noise request receiving unit 4140 receives a request for a noise selected by a user from the noise application 4200 of a user terminal.

The noise transmission unit 4150 transmits a noise received by the noise request receiving unit 4140 to the noise application 4200 of a user terminal. At this time, the noise transmission unit 4150 transmits noise information at the same time.

The affiliate advertisement management unit 4160 registers information about an advertisement sound or a discount coupon sound that is output while a noise is being output, and outputs the registered advertisement sound or discount coupon sound to the output noise. In this case, when the discount coupon sound is output, a discount coupon is also preferably displayed on a screen.

In addition, the noise application 4200 is installed in a user terminal, and communicates with the management center using unique identification information. The noise application 4200 includes an identification item management unit 4210, a noise list display unit 4220, a noise request unit 4230, a noise receiving unit 4240, a noise playback unit 4250, and a discount coupon display unit 4260.

The identification item management unit 4210 stores the unique identification information of the noise application 4200 stored in a terminal. In addition, when the management center is for members only, the identification item management unit 4210 may also store information about members.

The noise list display unit 4220 displays a noise list received from the noise management center 4100 on a screen.

When a user selects a noise from the noise list displayed on the screen, the noise request unit 4230 asks the noise management center 4100 to transmit the noise selected from. In this case, the noise file request unit may register a specific noise as a noise of interest, and may request transmission of the noise of interest.

The noise receiving unit 4240 receives noise files transmitted from the noise management center 4100. In this case, in the case of noises stored in the management center, the noise receiving unit 4240 receives noises as files. In the case of field noises, the noise receiving unit 4240 receives noises in a streaming manner.

The noise playback unit 4250 plays noises received by the noise receiving unit 4240. In this case, the noise playback unit 4250 may display noise information, pictures, or videos on a screen while playing a noise.

When a discount coupon corresponding to a discount coupon sound inserted into a noise received from the noise management center 4100 is received, the discount coupon display unit 4260 displays the discount coupon to allow a user to check the discount coupon. Accordingly, a terminal user may check or use the discount coupon by clicking a discount coupon icon.

When the customized noise relay system according to the fourth embodiment is used, by using a noise application installed in a user terminal, a user may receive and play noises while communicating with the noise management center.

Although the present invention has been described through limited examples and figures, the present invention is not intended to be limited to the examples. Those skilled in the art will appreciate that various modifications, additions, and substitutions are possible, without departing from the scope and spirit of the invention.

### MODE FOR INVENTION

The mode for carrying out the invention has been described in the best mode for carrying out the invention.

### INDUSTRIAL APPLICABILITY

The present invention relates to a customized noise relay system. Since the customized noise relay system can be implemented through a computer by a computer technology, the present invention has high industrial applicability.

1. A customized noise relay system, comprising a noise management center (1100) for directly outputting a noise to a noise user accessing an Internet site via wired or wireless connection,
wherein the noise management center (1100) comprises a noise management unit (1110) for managing noises; a noise list providing unit (1120) for displaying a list of noises managed by the noise management unit (1110) to allow a user accessing an Internet site linked to the noise management center (1100) to check the list; and a noise output unit (1130) for outputting a noise selected by the user from the displayed noise list.

2. A customized noise relay system, comprising a noise management center (2100) for directly outputting a noise to a noise user accessing an Internet site via wired or wireless connection; and a noise registration terminal (2200) for registering noises in the noise management center (2100),
wherein the noise management center (2100) comprises a noise management unit (2110) for managing noises; a noise list providing unit (2120) for displaying a list of noses managed by the noise management unit (2110) to allow a user accessing an Internet site linked to the noise management center (2100) to check the list; a noise output unit (2130) for outputting a noise selected by the user from the displayed noise list; a noise registrant management unit (2150) for storing and managing information about noise registrants who wish to register noise files or real-time field noises; a noise usage information management unit (2160) that is connected to the noise management center (2100) to manage a usage history of a noise user using noises; and a noise usage income calculation unit (2170) for, when income arises by outputting of noises, calculating a noise usage cost and paying the noise usage cost to registrants who have registered the noises, and
the noise registration terminal (2200) comprises a noise registration unit (2210) that is connected to the noise management center (2100) to register recorded noise files or real-time field noise information; a noise usage history management unit (2220) for receiving and managing a noise usage history when a registered noise is output or provided to a noise user through an Internet site linked to the noise management center (2100); and a noise usage cost management unit (2230) for, when a cost incurred by a registered noise used through the noise management center (2100) is calculated, receiving and managing the calculated information.

3. A customized noise relay system, comprising a noise management center (3100) for providing a matched dedicated noise to a customized dedicated noise output terminal (3200) via wired or wireless connection; and the customized dedicated noise output terminal (3200) for outputting the dedicated noise received from the noise management center (3100),
wherein the noise management center (3100) comprises a noise management unit (3110) for managing noises; a dedicated noise user registration unit (3120) for registering information about users who always want to receive a specific noise; a customized dedicated noise output terminal registration unit (3130) for registering and managing information about a dedicated noise terminal that always receives a specific noise from a dedicated noise user; a dedicated noise matching unit (3140) for matching a noise selected by the dedicated noise user with the customized dedicated noise output terminal (3200) registered by the dedicated noise user and storing the noise; and a dedicated noise transmission unit (3150) for providing a dedicated noise to the customized dedicated noise output terminal (3200) of the dedicated noise user stored in the dedicated noise matching unit (3140).

4. A customized noise relay system, comprising a noise management center (4100) for providing noises to a noise application (4200) of a user terminal via wired or wireless connection; and a user terminal installed with the noise application (4200) for outputting noises received from the noise management center (4100),
wherein the noise management center (4100) comprises a noise management unit (4110) for managing noises; a noise application management unit (4120) for managing information about the noise application (4200) installed in the user terminal; a noise list providing unit (4130) for providing a list of noises managed by the noise management unit (4110) to the noise application (4200) linked to the noise management center (4100); a noise request receiving unit (4140) for receiving a request for a noise selected by a user from the noise application (4200) of the user terminal; and a noise transmission unit (4150) for transmitting a noise received by the noise request receiving unit (4140) to the noise application (4200) of the user terminal, and
the noise application (4200) comprises an identification item management unit (4210) for storing unique identification information of the noise application (4200) stored in the terminal; a noise list display unit (4220) for displaying the noise list received from the noise management center (4100) on a screen; a noise request unit (4230) for, when a user selects a noise from the noise list displayed on the screen, requesting transmission of the selected noise to the noise management center (4100); a noise receiving unit (4240) for receiving a noise file transmitted from the noise management center (4100); and a noise playback unit (4250) for playing the noise received by the noise receiving unit (4240).

5. The customized noise relay system according to any one of claims 1 to 4, wherein the noise management units (1110, 2110, 3110, and 4110) consist of noise file management units (1111, 2111, 3111, and 4111) for storing and managing recorded noise files; and field noise management units (1112, 2112, 3112, and 4112) for managing field noise information to receive noises from fields in real time.

6. The customized noise relay system according to claim 5, wherein the field noise information receives a noise through real-time streaming and stores information about a location of the noise, a type of the noise, and an address provided through streaming.

7. The customized noise relay system according to any one of claims 1, 2, and 4, wherein, in the noise management centers (1100, 2100, and 4100), when the nose lists provided by the noise list providing units (1120, 2120, and 4130) are noise files, a ‘Listen’ menu and a ‘Download’ menu are displayed on a screen at the same time; and when the nose lists are field noises, a ‘Listen’ menu is displayed on a screen.

8. The customized noise relay system according to claim 1, wherein the noise management centers (1100 and 2100) further comprise affiliate advertisement management units (1140 and 2140) for registering information about an advertisement sound or a discount coupon sound that is output while a noise is being output and outputting the registered advertisement sound or discount coupon sound to the output noise.

9. The customized noise relay system according to claim 3, wherein the customized dedicated noise output terminal (3200) comprises various online sites, AI speakers, mobile terminals, smartphones, and TVs.

10. The customized noise relay system according to claim 3, wherein the dedicated noise matching unit (3140) matches different noises for each web page when registering a site with the customized dedicated noise output terminal (3200), or the dedicated noise matching unit (3140) matches different noises for each terminal when registering multiple terminals.

11. The customized noise relay system according to claim 4, wherein the noise management center (4100) further comprises an affiliate advertisement management unit (4160) for registering information about an advertisement sound or a discount coupon sound that is output while a noise is being output and outputting the registered advertisement sound or discount coupon sound to the output noise; and
the noise application (4200) further comprises a discount coupon display unit (4260) for, when a discount coupon corresponding to a discount coupon sound inserted into a noise received from the noise management center (4100) is received, displaying the discount coupon for a user to check the discount coupon.
